(19) United States
(12) Patent Application Publication
(10) Pub. No.: US 2009/0119023 A1
(43) Pub. Date: May 7, 2009

(54) Product Ecological and/or Environmental Rating System and Method

(75) Inventors: Shelley Zimmer, Boise, ID (US); Phillip S. Berry, Brooks, OR (US); Eraina Duffy, Aurora, OR (US); Katie L. Grew, Portland, OR (US); Vanessa H. Margolis, Beaverton, OR (US); Bryant T. Bainbridge, Portland, OR (US); William J. Malloch, Portland, OR (US)

Correspondence Address: BANNER & WITCOFF, LTD., 1100 13th STREET, N.W., SUITE 1200, WASHINGTON, DC, 20005-4051, US

(73) Assignee: NIKE, Inc., Beaverton, OR (US)

(21) Appl. No.: 12/111,784

(22) Filed: Apr. 29, 2008

Related U.S. Application Data
(60) Provisional application No. 60/915,483, filed on May 2, 2007.

(51) Int. Cl. G01N 31/00; G06F 19/00

(52) U.S. Cl. 702/22; 700/103

(57) ABSTRACT

Ecologically and/or environmentally conscious consumers and/or product manufacturers can “grade” the ecological and/or environmental character of products and/or their manufacturing methods. This grading may include one or more of: determining a type or amount of toxic material used in making the product and assigning a toxic consumption value for the product; determining a type or amount of waste created in making the product and assigning a waste production value for the product; determining a type or amount of environmentally preferred materials used in making the product and assigning a material value for the product; and determining an extent to which the product or its manufacturing methods provide an ecological or environmental advance over existing products or manufacturing methods and assigning an advancement value for the product. The final product grade then may be determined based on the assigned value or values.

### RELATED APPLICATION DATA

This application claims priority benefits based on U.S. Provisional Patent Application No. 60/915,483 entitled “Product Ecological and/or Environmental Rating System and Method,” filed May 2, 2007. This priority application is entirely incorporated herein by reference.

### FIELD OF THE INVENTION

This invention relates generally to grading systems and methods for evaluating and ranking consumer products based on their ecological and/or environmental impact. The invention provides a metric that enhances the ability of ecologically and/or environmentally conscious corporate citizens and consumers to design, rate, evaluate and/or compare products with an eye toward ecological and/or environmental issues.

### BACKGROUND

As the world population grows and technological advances are made, the demand for consumer goods of all types grows with it. The business world strives to meet this demand by providing a wide variety of consumer goods into the market for purchase.

The manufacture and marketing of consumer goods consumes natural resources in several ways. First of all, resources are included (and consumed) as part of the physical end product that is marketed to the consumer. Additionally, resources are consumed in the manufacture of many products, e.g., as chemicals, energy, and/or other raw materials or resources necessary to run the manufacturing plant and to produce the product. Further, resources may be consumed in cleaning up, storing, and/or otherwise handling waste and other by-products from the production processes. Carelessness, manufacturing inefficiencies, production errors, and/or other wastefulness can consume more natural resources than really would be necessary to produce the desired products. Moreover, some production processes utilize substantial amounts of toxic materials, such as solvents, whose later disposal can be difficult and/or expensive to handle and/or can cause environmental and/or health issues.

Many corporations and consumers care greatly about ecological and/or environmental issues and, when possible, they will take substantial steps to avoid adding to the earth's ecological and environmental problems, even if these steps will somewhat increase production and/or product costs. The advertising for many products touts their “environmentally friendliness” or “green” character. Unfortunately, for most consumer products, there is no easy way for manufacturers to distinguish the ecological and/or environmental impact of their products (and the manufacturing processes therefor) from competitor's products. Moreover, for most consumer products, there is no easy way for consumers to evaluate and compare one company's products against another, at least in terms of the ecological and/or environmental impact of production of one company's products as compared to another.

### SUMMARY

The present invention addresses some of the problems and issues identified above. The following text presents a general summary of aspects of the present invention in order to provide a basic understanding of the invention and various features of it. This summary is not intended to limit the scope of the invention in any way, but it simply provides a general overview and context for the more detailed description of the invention that follows.

In general, aspects of this invention provide ways for consumers, product manufacturers, and others to consistently evaluate, rank, and compare the ecological and/or environmental character of products and/or their manufacturing methods. In accordance with at least some examples of this invention, a method of grading the environmental/ecological character of a product may include: determining a type or amount of toxic material used in making the product; assigning a toxic consumption value for the product based on the determined type or amount of toxic material; determining a type or amount of waste created in making the product; assigning a waste production value for the product based on the type or amount of waste; determining a type or amount of environmentally preferred materials used in making the product; assigning a material value for the product based on the type or amount of environmentally preferred materials; determining an extent to which the product or its manufacturing methods provide an advance over similar conventional or existing products and manufacturing methods; assigning an advancement value for the product based on the determined advance extent; and determining a product grade, at least in part, based on the assigned toxic consumption value, waste production value, material value, and advancement value. The “determining” steps may involve physical measurements (such as detecting, sensing, or measuring the types or amounts of various materials included in or used in manufacture of the product), and/or they may involve receiving input from an external source.

### BRIEF DESCRIPTION OF THE DRAWINGS

A more complete understanding of the present invention and certain advantages thereof may be acquired by referring to the following detailed description in consideration with the accompanying drawings, in which:

FIG. 1 illustrates a general diagram of a computer system that may be used in conjunction with various aspects of this invention;

FIGS. 2A and 2B illustrate potentially improved ecological and/or environmental results achieved when using grading systems in accordance with an example of this invention;

FIG. 3 illustrates categorization and grading of products in accordance with this invention under “gold,” “silver,” and “bronze” characterizations;

FIG. 4 illustrates an example of Product Chemistry Parameter Scoring used in grading systems and methods in accordance with at least some examples of this invention;

FIG. 5 illustrates an example Solvent Worksheet that may be used in evaluating solvent presence and content in a product production process in accordance with at least some examples of this invention;

FIG. 6 illustrates an example of Waste Parameter Scoring used in grading systems and methods in accordance with at least some examples of this invention;

FIG. 7 illustrates an example of Environmentally Preferred Material Parameter Scoring used in grading systems and methods in accordance with at least some examples of this invention;

FIG. 8 illustrates an example of Innovation Parameter Scoring used in grading systems and methods in accordance with at least some examples of this invention; and

FIG. 9 illustrates an example of Total Product Grade Scoring used in grading systems in accordance with at least some examples of this invention.

### DETAILED DESCRIPTION

### I. General Description of Product Grading Methods and Systems, and the Use Thereof, According to this Invention

Aspects of this invention provide ways for consumers, product manufacturers, and others to consistently evaluate, rank, and compare the ecological and/or environmental character of products and/or their manufacturing methods. In accordance with at least some examples of this invention, methods of grading products may include: determining a type or amount of toxic material used in making the product; assigning a “toxic consumption value” for the product based on the determined type or amount of toxic material; determining a type or amount of waste created in making the product; assigning a “waste production value” for the product based on the type or amount of waste; determining a type or amount of environmentally preferred materials used in making the product; assigning a “material value” for the product based on the type or amount of environmentally preferred materials; determining an extent to which the product or its manufacturing methods provide an advance over similar conventional or existing products (e.g., prior year models, etc.) and/or their manufacturing methods; assigning an “advancement value” for the product based on the determined extent; and determining a product grade, at least in part, based on the assigned toxic consumption value, waste production value, material value, and advancement value.

Additional aspects of this invention relate to other features of product grading methods that may be used according to at least some examples of this invention. Such features of the invention may include: (a) receiving input indicating a type or amount of toxic material used in making the product; (b) receiving input indicating a type or amount of waste created in making the product; (c) receiving input indicating a type or amount of environmentally preferred materials used in making the product; (d) receiving input indicating an extent to which the product or its manufacturing methods provide an advance over similar conventional or existing products and manufacturing methods; and (e) determining a product grade based, at least in part, on the received inputs.

Still additional aspects of this invention relate to methods of grading products that may include: (a) determining plural product “sub-scores,” wherein the sub-scores are based, at least in part, on at least two members selected from the group consisting of: a type of toxic material used in making the product, an amount of toxic material used in making the product, a type of waste created in making the product, an amount of waste created in making the product, a type of environmentally preferred materials used in making the product, an amount of environmentally preferred materials used in making the product, and an extent to which the product or its manufacturing methods provide an advance over similar conventional or existing products and/or their manufacturing methods; and (b) determining a product grade based, at least in part, on the product sub-scores.

Furthermore, aspects of this invention may include associating the determined product grade with the product in some manner, e.g., in a manner that is easily locatable and identifiable by a consumer, such as by marking the product grade directly on the product or on packaging for the product; by applying a tag to the product that includes the product grade indicated thereon; by including the product grade in advertising, literature, or other information relating to the product; etc.

Aspects of this invention may be applied to any desired type of product without departing from this invention, including any type of consumer product (e.g., available in retail, wholesale, or discount stores, etc.). Examples of such products include, but are not limited to: footwear, apparel, electronic goods, appliances, jewelry, paper products, food, leather goods, grocery items, furniture, school/office supplies, automobiles and/or other vehicles, sporting equipment (such as balls, bags, bats, gloves, protective equipment, etc.), etc.

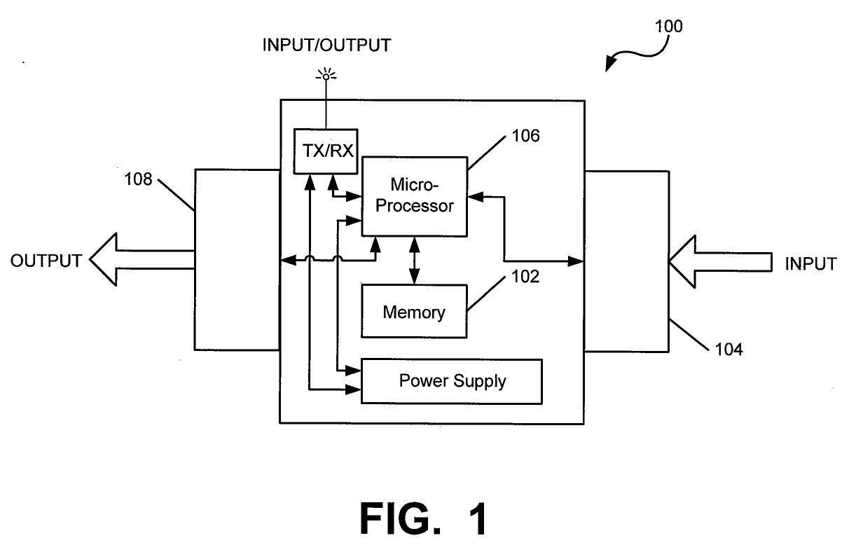

The various methods described above, or at least portions thereof, may be performed by a computer 100 (see FIG. 1) that is programmed and adapted to carry out the various steps (e.g., programmed and adapted to receive any necessary inputs; programmed and adapted to obtain or determine the various values or sub-scores (e.g., by a calculation method, by obtaining the necessary information from memory 102 or a “look-up” table, by obtaining the necessary information from detectors or sensors connected to the computer, by making physical measurements on the product, etc.); programmed and adapted to obtain or determine the product score based on the input values and/or the sub-scores (e.g., by a calculation method, by obtaining the necessary information from memory 102 or a “look-up” table, by obtaining the necessary information from detectors or sensors connected to the computer, by making physical measurements on the product etc.); etc.). Any type of computer system 100 may be programmed and used to perform some or all portions of methods according to this invention, including, for example, personal computers, mainframe computers, handheld computers, laptops, palmtops, etc. The programs for controlling the computer 100 to perform the various steps may be stored on any desired type of computer-readable medium as are known and used in the art, including computer floppy disks, CDs, DVDs, hard disks, and/or other memory systems (generally designated as memory 102 in FIG. 1).

Product grading systems in accordance with at least some examples of this invention may include: (1) an input system (e.g., system 104 in FIG. 1) for receiving input indicating one or more of the following: (a) a type and/or amount of toxic material used in making the product, (b) a type and/or amount of waste created in making the product, (c) a type and/or amount of environmentally preferred materials used in making the product, and/or (d) an extent to which the product and/or its manufacturing methods provide an advance over similar conventional or existing products and/or their manufacturing methods; and (2) a processing system (e.g., system 106 in FIG. 1, including one or more processors) programmed and adapted to perform one or more of the following operations: (a) assign a toxic consumption value for the product based on the type and/or amount of toxic material, (b) assign a waste production value for the product based on the type and/or amount of waste, (c) assign a material value for the product based on the type and/or amount of environmentally preferred materials used in making the product, and/or (d) assign an advancement value for the product based on the determined extent by which the product and/or its manufacturing method provide an advance. The processing system further may be programmed and adapted to: (e) determine a product grade based on one or more of the assigned toxic consumption value, waste production value, material value, and/or advancement value. Any desired type of input systems may be provided without departing from this invention, such as one or more of a keyboard, a mouse, a data connection to a remote device or network (such as a LAN or WAN connection), an infrared or other data input port, an input line from a detector or sensor that measures or detects a characteristic of the product, etc. The various inputs may be received over different input systems without departing from this invention.

Systems in accordance with at least some examples of this invention further may include an output system (e.g., system 108 in FIG. 1) for providing the product grade to the user, e.g., a device for marking the determined product grade on the product or packaging for the product (e.g., a printer or other marking device for printing the product grade on the product, its packaging, on a tag for the product, on advertising literature for the product, etc.), a display screen, etc. As noted above, conventional computer systems (e.g., of the types described above) may be programmed and adapted to perform the various functions of systems in accordance with examples of this invention.

Additional aspects of this invention relate to manners in which product grades, systems, and methods in accordance with this invention may be used, e.g., to design a product or its manufacturing method and/or to redesign or modify a product and/or its manufacturing method. Such methods may include methods for producing a product that include: (a) determining an initial product grade for an initial product made using a first product manufacturing process, wherein the product grade provides a measure of environmental or ecological aspects of at least one of the initial product or the first manufacturing process, and wherein the initial product grade is based, at least in part, on at least two members selected from the group consisting of: a type of toxic material used in making the product, a type of waste created in making the product, an amount of toxic material used in making the product, a type of environmentally preferred material(s) used in making the product, an amount of waste created in making the product, an amount of environmentally preferred material(s) used in making the product, and an extent to which the product or its manufacturing methods provide an advance over similar conventional or existing products and/or their manufacturing methods; (b) changing at least one aspect of the first product or the first manufacturing process to improve the environmental or ecological aspects; and (c) making a final product using the changed aspect of the product and/or its manufacturing process, wherein the final product has an improved product grade as compared to the initial product grade. These aspects of the invention further may include marking the improved product grade on the product or packaging for the product, e.g., in any of the various manners described above. As noted above, aspects of this invention may be applied to a wide variety of different products and the like.

In view of the foregoing general description, a more detail description follows of various specific examples of grading methods and systems according to this invention, as well as their use. While the specific examples generally relate to production of footwear or apparel, those skilled in the art will understand that aspects of this invention can be extended to other products.

### II. Description of Specific Examples of Product Grading Methods and Systems According to this Invention

Specific examples of the invention now will be described in more detail in conjunction with the attached figures. Those skilled in the art will understand, however, that these specific examples merely illustrated potential features and characteristics of the invention and do not limit the invention.

In accordance with aspects of this invention, consumer products generally can be classified into two major classes, namely, products that include (or have been modified to include) improved ecological and/or environmental characteristics (or have at least been designed with their ecological and/or environmental impact in mind) and other products. Various concrete steps may be taken in product design and/or its manufacturing method to improve its ecological and/or environment characteristics and/or impact. For example, products that are made using lower amounts of toxic materials (such as solvents, carcinogens, etc., during product manufacture) and/or using more ecologically and/or environmentally friendly materials (e.g., less corrosive or severe solvents, water-based solvents v. organic solvents, etc.) during the manufacturing process may be considered improvements over products made using larger amounts of toxic materials and/or more harsh materials.

Other major ecological and/or environmental factors that may be considered in systems and methods according to examples of this invention relate to waste generated during manufacturing processes of consumer products. Products and manufacturing processes that generate less waste (and/or more easily handle-able waste) may be considered an improvement over products and/or manufacturing processes that generate large amounts of waste or waste materials that require special handling.

Additional factors that may be considered in evaluating a product's overall ecological and/or environmental impact relate to the type(s) of materials that make up the product itself. Certain materials, whether raw materials included as part of the product or used in making the product, are simply more environmentally friendly than others (or have a lesser degree of adverse impact on the environment). For example, the product may be designed to use recycled, renewable, or regenerated materials. Therefore, designing and producing products having an increased amount of “environmentally friendly” or “environmentally preferred” materials and/or manufacturing methods (as compared to similar existing or conventional materials and/or methods) may be seen as an improvement in the product design and/or its manufacture over products that use all “new” materials.

Still additional features relating to the environmental and/or ecological impact of a product relate to the product design and/or the design of its manufacturing process. When environmental and ecological impact is taken into account during product design and design of its manufacturing process, changes to the product and/or processes (e.g., innovations) can result in modified products and/or processes having significantly improved ecological and/or environmental characteristics. For example, combining cleaning steps to save water or other cleaning materials may lead to a significant reduction in material consumption. Such innovations should be encouraged.

The present invention, as will be described in more detail below, provides grading systems for products that take these (and potentially other) environmental and/or ecological characteristics in mind. In accordance with some examples of this invention, products are graded based on one or more of toxic material use, waste generation, use of environmentally friendly materials, and development and use of innovations relating to the environmental/ecological character of the product and/or process. Such grading systems can provide a metric that product designers and/or manufacturers can use in an effort to evaluate and/or improve the ecological and/or environmental characteristics of their products. Such grading systems also can be used by designers and manufactures in setting “goals” in an effort to design and produce ecological and environmentally improved products. The grading systems also can be used by end consumers to evaluate, compare, and contrast different products (optionally from different manufacturers) and provide a metric to enable them to purchase more ecologically and/or environmentally friendly products and/or to patronize more ecologically and environmentally conscious businesses.

The above noted portions of this example grading system are simply some specific examples of parts or sub-parts that may be used in grading system calculations or determinations in accordance with this invention. Some or all of these portions may be used in a specific grading system without departing from the invention, and/or these various parts and/or sub-parts may be weighted differently in various grading system calculations and/or determinations without departing from this invention. Additional elements or features may be included or taken into account in the grading system calculations or determinations (e.g., in addition to or optionally in place of one or more of the parts and/or sub-parts described above) without departing from this invention. More specific examples of such elements or features may include socially responsible considerations, such as compliance with various labor standards (e.g., paying a living wage, presence or absence of child labor, factory working conditions, etc.); generation of a large carbon footprint; generation and/or atmospheric release of carbon dioxide, sulfur oxides, greenhouse gases, and/or the like; generation and/or atmospheric release of ozone depleting chemicals; features of the packaging for the product (e.g., presence of waste, disposal issues, etc.); and the like.

Product grading systems in accordance with at least some examples of this invention can be useful to challenge designers and/or product manufacturers to develop environmentally and ecologically friendly products without adversely impacting the product's performance and/or aesthetic appearance. These features or elements also can be worked into the grading system, if desired. For example, a product may lose points in the overall grading system if it sacrifices performance characteristics and/or aesthetics in an effort to improve its score in other of the environmental/ecological ways. Also, products that may get a “low grade” in grading systems in accordance with at least some examples of the invention may include: (a) products in which a minimal effort is made toward using environmentally preferred materials and/or in reducing wastes and/or toxics; (b) products that include materials from any animal species globally listed as threatened or endangered; (c) products that include polyvinylchlorides (“PVCs”); (d) products that include components that inhibit recyclability (e.g., metal components in footwear); (e) products that achieve only aesthetic improvements; and/or (f) products or manufacturing processes in which the efforts made to improve the ecological and/or environmental impact did not achieve the desired result. Other characteristics of a product and/or its manufacturing process (such as various social responsibility/“good corporate citizen” factors) also may adversely affect the product's “grade.”

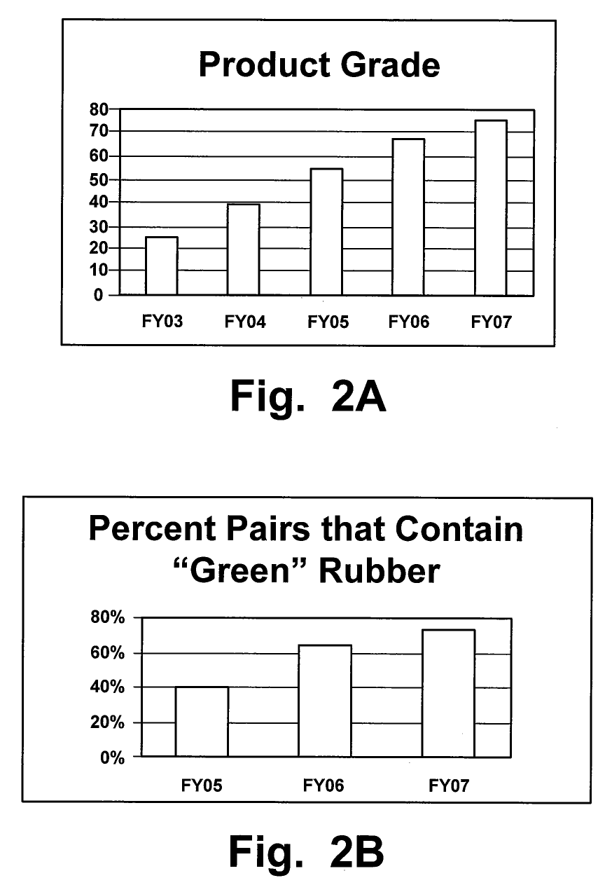

One advantage of use of grading systems, e.g., of the types of this invention, relates to the enhanced designer and/or manufacturer “awareness” and consideration of ecological and/or environmental issues in the design and manufacture of consumer products. FIG. 2A illustrates the potential ecological and/or environmental grade improvement achieved, at least in part, through the use of grading systems of the types described above (and of the types to be described in more detail below). Experimental tests using an example grading system for footwear products began in FY03. As shown in FIG. 2A, at that time, the average “grade” for a footwear product was about 27. Continued use of the grading system, however, heightened the ecological and/or environmental issues in the designer's minds, which resulted in about a 200% increase in grade score for products by FY07 (a grade of about 85). Moreover, the use of “green” chemistry programs allowed this manufacturer to reduce toxics consumption by about 96% by weight in making footwear rubber. As shown in FIG. 2B, the user of an ecological and/or environmental grading system in this test group resulted in an increase in usage of “green” rubber (with its lower toxic levels) by about 72% in 3 years (from FY05 to FY07).

Accordingly, grading systems of the types described above (and to be described in more detail below) can help manufacturers and/or designers become more aware of ecological and environmental issues, driving them to improve the designs and manufacturing techniques in an effort to improve their “grade.”

We now turn to a more detailed analysis and description of example grading systems in accordance with this invention. For this specific example system, four main features or characteristic of a product and/or its manufacturing process are evaluated, as shown in Table 1 below:

TABLE 1
Example Product Grading Scheme

| Parameter | Practical Feature Evaluated | Scoring |
|---|---|---|
| Product Chemistry | Use of Solvents | Points |
| Waste Reduction | Manufacturing Process | Points |
| Use of Environmentally | Average Material Score | Points |
| Preferred Materials | | |
| Innovations | Number of Problems Solved | Points |

TOTAL POINTS:

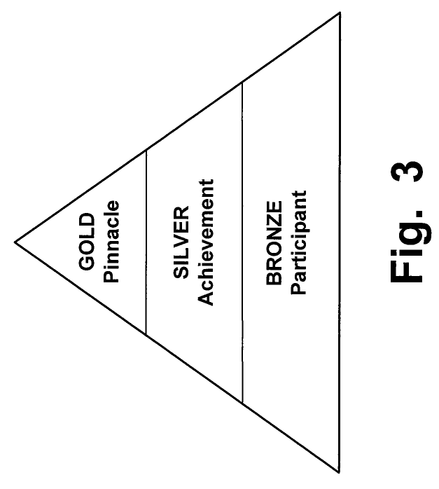

The total points or score for the product may be converted to an even more general metric, such as “gold,” “silver,” or “bronze” product characterizations, e.g., as shown in FIG. 3. The appropriate numbers of points for each parameter, the weighting of points over the various parameters, and/or the specific point ranges for each “general” product characterization (e.g., such as the “gold,” “silver,” or “bronze” product characterizations) may be set and selected in any manner, e.g., through routine experimentation (e.g., to provide adequate incentives without being so difficult as to be impossible or nearly impossible to achieve and/or too easy to achieve). Different ranges also may apply to different types of products.

The various features of the above-noted parameters as used in one example grading scheme in accordance with this invention will be evaluated in more detail below.

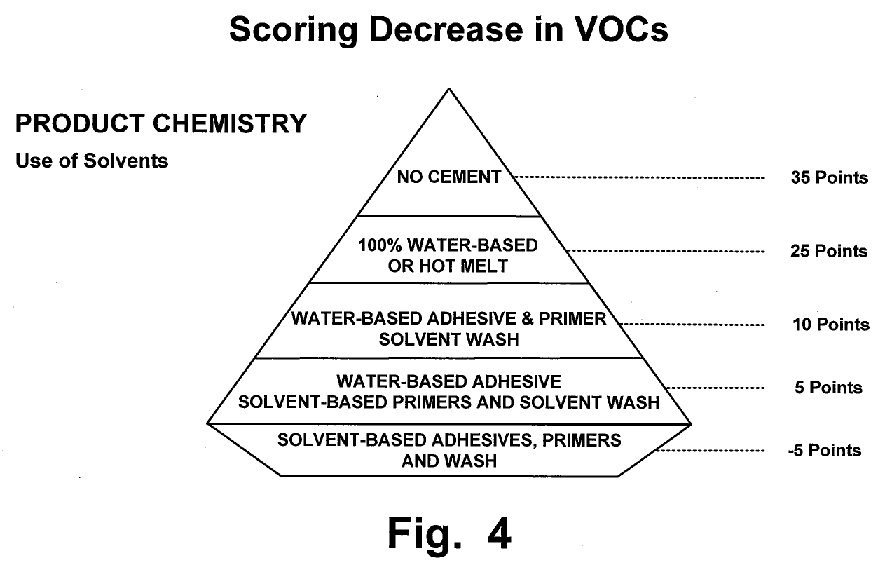

First, in conjunction with FIG. 4, a potential scoring scheme for the Product Chemistry Parameter (use of solvents) will be discussed. For footwear manufacture, which is the product line associated with this example grading system, various numbers of points are awarded (or deducted) depending on the type(s) of solvent used, the amount of solvents used, the process(es) and/or number of process steps in which they are used, etc. For example, as shown in FIG. 4, in general, a decrease in the use of volatile organic compounds (“VOCs”) will result in an increasing number of points awarded toward the grade for this parameter. In products and manufacturing processes in which no cements are used, 35 points are awarded in this example grading system. Products and processes that use 100% water-based or hot melt materials are awarded 25 points in this grading system. Products and methods that use water-based adhesives and primers with a solvent wash are awarded 10 points in this grading system. Products and processes that use water-based adhesives but solvent-based primers and solvent washes are awarded only 5 points in this example grading system. Finally, 5 points are deducted from the sub-score of products and processes that use solvent-based adhesives, primers, and washes in this example grading system.

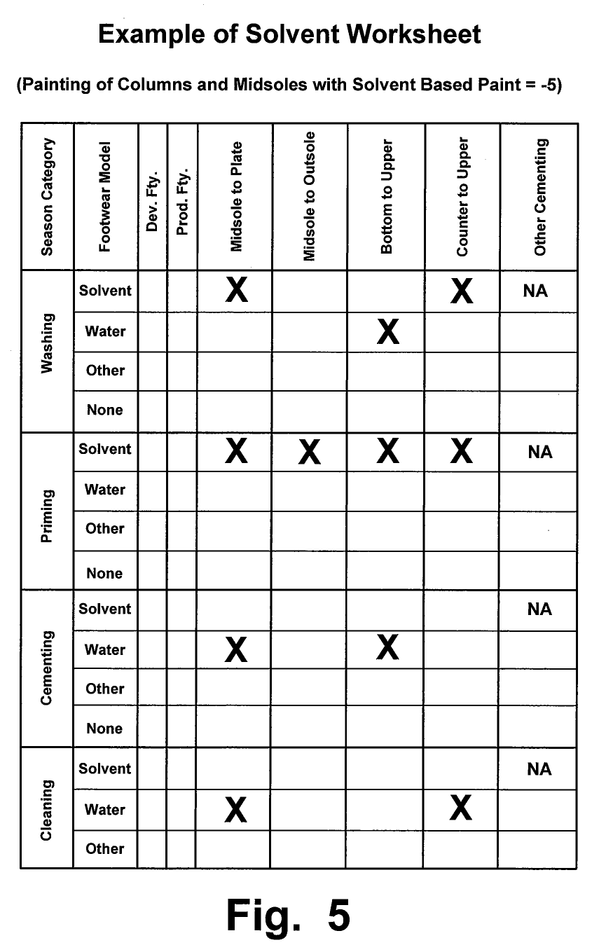

FIG. 5 illustrates an example solvent usage worksheet that can help footwear designers and/or manufacturers evaluate and consider where solvents might be used in footwear product processes and/or how or where the use of such solvents may be modified or avoided. Use of this type of worksheet during the design phase can help designers design around the use of volatile chemicals at various points in the manufacturing processes and make them more aware of the scoring or grading at the various potential steps in the footwear production process. This awareness can help designers think more creatively of ways to eliminate and/or reduce usage of volatile organics.

Other features of a shoe design and/or its manufacturing process also may affect the Product Chemistry Parameter. As illustrated in FIG. 5, the use of solvent based paint on the midsole and/or other portions of the footwear structure (such as impact-attenuating elements) in this example grading system results in a deduction of 5 points. Other product features may result in a Product Chemistry Parameter score addition or subtraction, depending on the ecological and/or environmental impact of that product feature and its desired importance (or weight) in the overall grading system.

Additionally or alternatively, if desired, the overall average weight of solvents used per pair of shoes (optionally also taking into consideration the type of solvent) may be used, at least in part, as an element in determining the value to be assigned for the Product Chemistry Parameter.

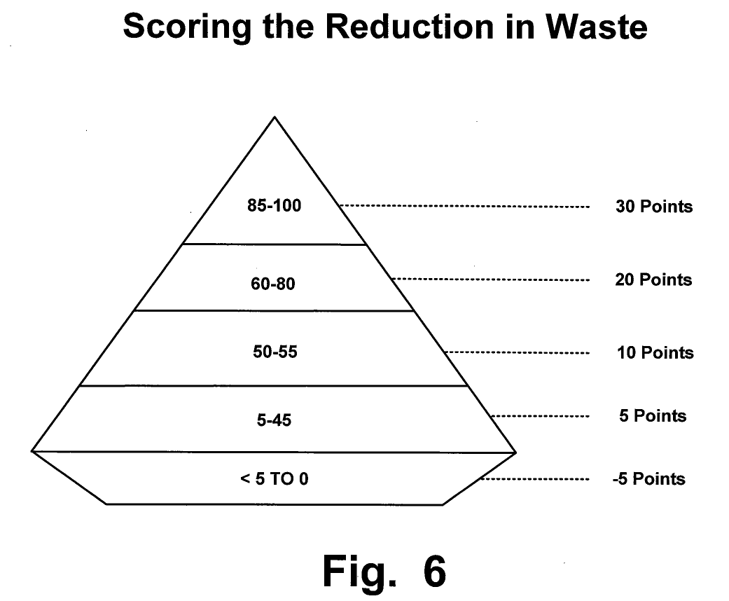

Next, scoring relating to the type and/or amount of (or reduction in the amount of) waste material generated during the manufacturing process in this example grading system will be discussed in conjunction with FIG. 6. Waste may be generated at various different parts of the manufacturing process and/or with the manufacture of many different parts of a footwear structure. Efficient use of the base material and/or manufacturing efficiency are some ways of evaluating waste. For example, in ascertaining the amount of waste generated in a footwear production method, one may consider one or more of: (a) upper pattern efficiency (e.g., what percentage of the upper blank is used in the final product or thrown out); (b) midsole construction (e.g., how much material is cut away and/or thrown out); (c) sockliner construction (e.g., how much material is cut away and/or thrown out); (d) use of high frequency (“HF”) welding techniques; and/or (e) tooling efficiency.

The following table illustrates one example of scoring relating to waste material in the grading system in accordance with this example of the invention:

TABLE 2
Waste Parameter Grading Waste Worksheet

| MIDSOLE (30% of total Waste score) | 30 pts total |
|---|---|
| No Midsole Used | 30 pts |
| DP/DU-Direct Phylon or Unit sole | 30 pts |
| CMP/CMU-Direct Pre-form | 25 pts |
| IP, IU or PU | 20 pts |
| CMP or CMU w/IP Pre-form | 20 pts |
| PP-PU/PH Interlock | 15 pts |
| DH-Dual Hardness Phylon | 15 pts |
| CMP w/Buffed Sheet Stock Pre-form | 0 pts |
| EV-Buffed EVA Sheet Stock | 0 pts |
| M/S &O/S TOOLING | |
| Reduce total tooling use of model | 5 pts |
| Re-use tooling | 5 pts |
| UPPER (60% of total score) | 60 pts total |
| 75-80% pattern efficiency or greater | 60 pts |
| 70-75% pattern efficiency | 30 pts |
| 65-70% pattern efficiency | 20 pts |
| 60-65% pattern efficiency | 10 pts |
| 55-60% pattern efficiency | 0 pts |
| <55% pattern efficiency or less | −5 pts |
| SOCKLINER(10% of total score) | 10 pts total |
| Single Layer Foam | 10 pts |
| DECORATION | |
| HF Welding | −5 pts |
| TOTAL WASTE SCORE | |
| Add it up | xxx/100 |

The total waste sub-score (30% of which is based on midsole features, 60% of which is based on upper features, and 10% of which is based on sockliner features, with potential deductions for various other features, such as the inclusion of high frequency welding steps) then may be used to determine the value for the Waste Parameter to be used in this example grading system and method. For example, the total waste score from the Table above is evaluated based on the information contained in FIG. 6 in this example grading system and method to determine the Waste Parameter score. As shown in FIG. 6, a total waste score of 85 or more (up to a maximum of 100) results in a 30 point Waste Parameter score. A total waste score of 60-80 results in a 20 point Waste Parameter score. Likewise, a total waste score between 50 and 55 results in a 10 point Waste Parameter score, and a total waste score between 5 and 45 results in a 5 point Waste Parameter score. A total waste score lower than 5 will result in a −5 point Waste Parameter score.

Additionally or alternatively, if desired, the actual amount (or average amount) of waste per pair of shoes may be considered in determining the value to be used for the Waste Parameter score. Other features and aspects of the waste also may be taken into account in determining the total waste score and/or the Waste Parameter score, such as waste shipping or other waste handling costs.

Next, the presence or absence of environmentally preferred materials in a footwear structure will be evaluated for determining an Environmentally Preferred Material (“EPM”) Parameter score in this example grading system and method. Different environmentally preferred materials will be worth different amounts of points (different weighting). The “better” the material, the more it is worth. For example, if a manufactured article uses an environmentally preferred rubber (e.g., in a shoe) the article may get a certain number of points (e.g., 11 points), if the article uses recycled laces it may get another number of points (e.g., 2 points), etc. In general, the Environmentally Preferred Material Parameter score in this example grading system may constitute the total sum of the EPM points for the product (the total number of EPMs in the product or the total number of individual EPM parts or pieces divided by the total number of different materials in the product or the percentage of EPMs in the overall product). More particularly, this example Environmentally Preferred Material Parameter score may be calculated as follows:

$$\frac{Total Sum E P M Points in product}{No . Unique Materials in the product} 100 = Raw E P M Score$$

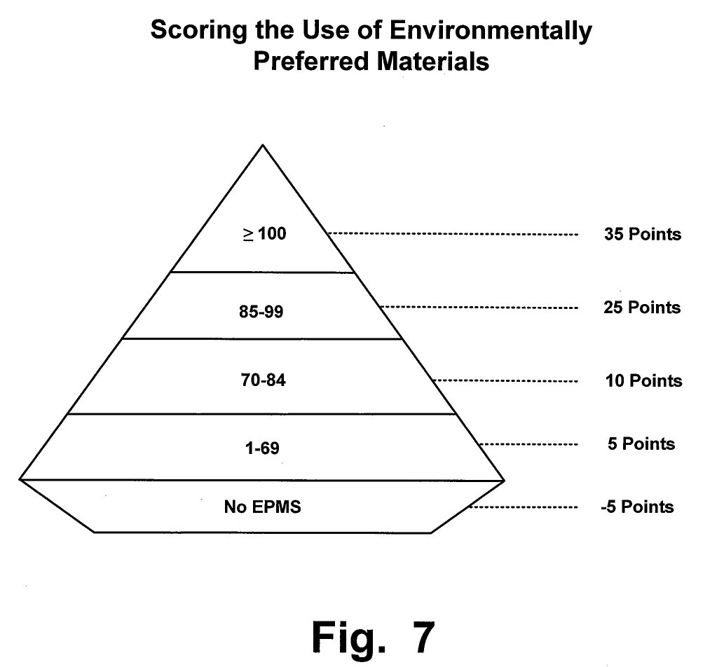

Using FIG. 7, the Raw EPM score is converted to the Environmentally Preferred Material Parameter score. In this example grading system, a Raw EPM Score of 100 or greater will result in an Environmentally Preferred Material Parameter score of 35. A Raw EPM Score of 85-99 will result in an Environmentally Preferred Material Parameter score of 25. Likewise, a Raw EPM Score of 70-84 will result in an Environmentally Preferred Material Parameter score of 10, and a Raw EPM Score of 1-69 will result in an Environmentally Preferred Material Parameter score of 5. The presence of no environmentally preferred materials in the footwear structure of this example grading system and method will result in a −5 Environmentally Preferred Material Parameter score. These ranges may be adjusted, the number of ranges, and/or the number of points awarded for a given range may be adjusted without departing from this invention. Additional factors may be taken into consideration, such as the weight percentage of EPMs in the product, the specific types of EPMs in the product, etc.

Many materials may be considered “environmentally preferred materials” without departing from this invention. For example, easily recyclable, recycled, or regenerated materials may be considered as “environmentally preferred materials.” Use of biodegradable materials (yet wear resistant, e.g., not hard plastics) also may be considered environmentally preferred. As additional examples, use of renewable materials (such as bamboo, organic cotton, etc.) may be considered “environmentally preferred,” as may the use of chemically optimized materials (e.g., environmentally preferred rubber, made with a minimal or reduced amount of VOC's etc.).

Also, any desired part(s) of the product may be made from environmentally preferred materials without departing from this invention. For footwear, this may include, for example, portions of the upper interior lining, the stroebel, reinforcing or stiffening materials, the sockliner, the counter, the midsole, the outsole, impact-attenuating materials, the upper exterior, etc.

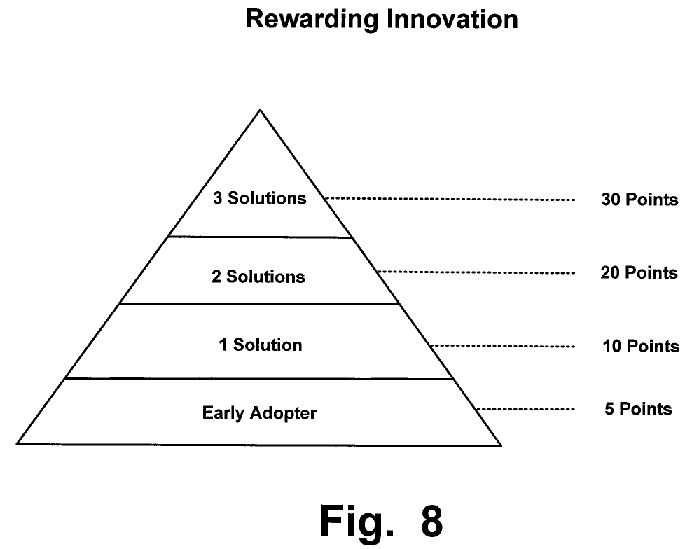

Innovation in the product design and/or the manufacturing process also may be “rewarded” in grading systems in accordance with examples of the invention (called the “Innovations Parameter score” below). For example, the number of “problems” solved may be evaluated for a given product and/or its manufacturing process, and this number may be used in determining the Innovations Parameter score. As shown in FIG. 8, solving three problems results in an Innovations Parameter score of 30. Solving two problems results in an Innovations Parameter score of 20, and solving one problem results in an Innovations Parameter score of 10. Becoming an early adopter of newly developed technology that favorably impacts ecological and/or environmental characteristics of a product or process also can gain an Innovations Parameter score of 5 points in this example grading system.

Various features may be included and considered in compiling the Innovations Parameter score without departing from this invention. For example, products and processes that generate little or no waste, that re-use or re-purpose existing materials, designs, or machinery, that use existing packaging, and/or that reduce or eliminate packaging all together, or other features may be considered “innovative” for purposes of this parameter and scoring. Products and processes that have simplified or reduced construction or assembly, require use of less energy, and/or require use of less water may be considered “innovations” for purposes of this parameter and scoring. As still additional examples, recyclability, ease of disassembly, compostability, and use of single fibers and/or polymers (to enable easy recycling) may be consider innovative for purposes of this parameter and this scoring system and method. Products and processes that use local source vendors and/or local manufacturing facilities also may be considered innovations (given the shipping, time, fuel consumption, and energy savings involved). Products that are multifunctional, durable, and have a long life span also may be considered innovative for this scoring parameter. Other innovations also are possible without departing from this invention.

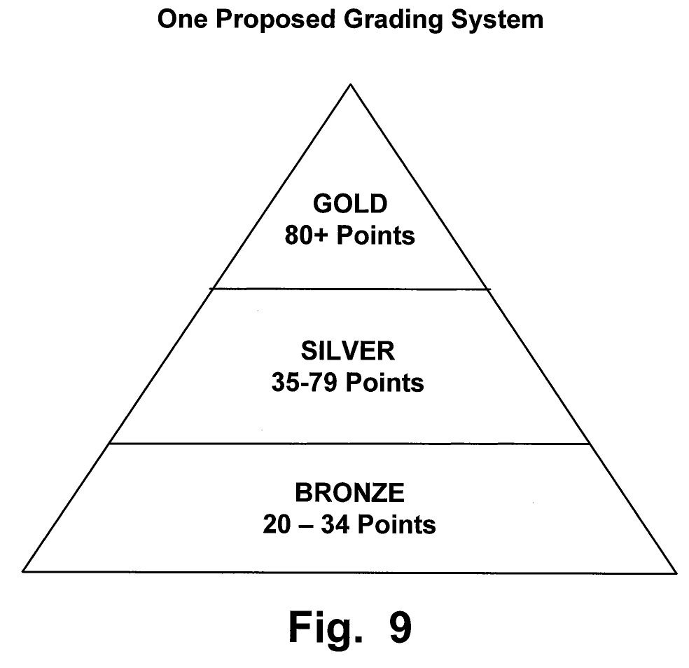

Once the various Parameter scores are determined (e.g., from Table 1, determined as described above), the total Product Score or grade then may be determined e.g., by adding the individual parameter scores together—i.e., by adding the Product Chemistry Parameter, the Waste Parameter, the Environmentally Preferred Material Parameter, and the Innovations Parameter scores as described above in this example system and method. If desired, weighting factors may be applied to further control the influence of the various parameters on the overall Product Score. This total score (which can be considered the product grade) also may be evaluated for “gold,” “silver,” “bronze,” or “no” status, e.g., using the evaluation parameters shown in FIG. 9. More specifically, in this example grading system, “gold” status is awarded to products achieving a total product grade of at least 80 points. “Silver” status is awarded to products achieving a total product grade of 35-79 points, and “bronze” status is awarded to products achieving a total product grade of 20-34 points. No ecological or environmentally improved status is awarded in this grading system and method to products having a total product grade of less than 20 points.

Aspects of this invention extend beyond footwear product grading. Rather, a suitable grading system may be developed for any desired type of product, using any desired parameters and/or combinations of parameters, without departing from this invention. Additionally, if desired, the various ranges and endpoints thereof for determining the various parameters and scores may be adjusted without departing from this invention.

### III. Conclusion

While the invention has been described in detail in terms of specific examples including presently preferred modes of carrying out the invention, those skilled in the art will appreciate that there are numerous variations and permutations of the above described systems and methods. Thus, the spirit and scope of the invention should be construed broadly as set forth in the appended claims.

We claim:

1. A method of grading a product, comprising:
determining at least one of a type or amount of toxic material used in making the product;
assigning a toxic consumption value for the product based on the determined type or amount of toxic material;
determining at least one of a type or amount of waste created in making the product;
assigning a waste production value for the product based on the type or amount of waste;
determining at least one of a type or amount of environmentally preferred materials used in making the product;
assigning a material value for the product based on the type or amount of environmentally preferred materials;
determining an extent to which the product or its manufacturing methods provide an advance over existing products or manufacturing methods;
assigning an advancement value for the product based on the determined extent; and
determining a product grade based on the assigned toxic consumption value, waste production value, material value, and advancement value.

2. A method according to claim 1, further comprising:
marking the product grade on the product or packaging for the product.

3. A method according to claim 1, further comprising:
applying a tag to the product, wherein the tag includes the product grade indicated thereon.

4. A method according to claim 1, wherein the product is footwear.

5. A method according to claim 1, wherein the product is apparel.

6. A method according to claim 1, wherein the product is sports equipment.

7. A computer-readable medium including computer-readable instructions stored thereon for performing the method of claim 1.

8. A method of grading a product, comprising:
receiving input indicating at least one of a type or amount of toxic material used in making the product;
receiving input indicating at least one of a type or amount of waste created in making the product;
receiving input indicating at least one of a type or amount of environmentally preferred materials used in making the product;
receiving input indicating an extent to which the product or its manufacturing methods provide an advance over existing products or manufacturing methods;
determining a product grade based, at least in part, on the received inputs.

9. A method according to claim 8, further comprising:
marking the product grade on the product or packaging for the product.

10. A method according to claim 8, further comprising:
applying a tag to the product, wherein the tag includes the product grade indicated thereon.

11. A method according to claim 8, wherein the product is footwear.

12. A method according to claim 8, wherein the product is apparel.

13. A method according to claim 8, wherein the product is sports equipment.

14. A computer-readable medium including computer-readable instructions stored thereon for performing the method of claim 8.

15. A method of grading a product, comprising:
determining plural product sub-scores, wherein the sub-scores are based, at least in part, on at least two members selected from the group consisting of: a type of toxic material used in making the product, an amount of toxic material used in making the product, a type of waste created in making the product, an amount of waste created in making the product, a type of environmentally preferred material used in making the product, an amount of environmentally preferred materials used in making the product, and an extent to which the product or its manufacturing methods provide an advance over existing products or manufacturing methods; and
determining a product grade based, at least in part, on the product sub-scores.

16. A method according to claim 15, further comprising:
marking the product grade on the product or packaging for the product.

17. A method according to claim 15, further comprising:
applying a tag to the product, wherein the tag includes the product grade indicated thereon.

18. A method according to claim 15, wherein the product is footwear.

19. A method according to claim 15, wherein the product is apparel.

20. A method according to claim 15, wherein the product is sports equipment.

21. A method according to claim 15, further comprising:
receiving one or more inputs relating to at least one member selected from the group consisting of: the type of toxic material used in making the product, the amount of toxic material used in making the product, the type of waste created in making the product, the amount of waste created in making the product, the type of environmentally preferred materials used in making the product, the amount of environmentally preferred materials used in making the product, and the extent to which the product or its manufacturing methods provide an advance over existing products or manufacturing methods, wherein the inputs are used in determining the product sub-scores.

22. A computer-readable medium including computer-readable instructions stored thereon for performing the method of claim 21.

23. A computer-readable medium including computer-readable instructions stored thereon for performing the method of claim 15.

24. A method of producing a product, comprising:
determining an initial product grade for an initial product made using a first product manufacturing process, wherein the product grade provides a measure of environmental or ecological aspects of the initial product or the first manufacturing process, and wherein the initial product grade is based, at least in part, on at least two members selected from the group consisting of: a type of toxic material used in making the product, an amount of toxic material used in making the product, a type of waste created in making the product, an amount of waste created in making the product, a type of environmentally preferred materials used in making the product, an amount of environmentally preferred materials used in making the product, and an extent to which the product or its manufacturing methods provide an advance over existing products or manufacturing methods;
changing at least one aspect of the first product or the first manufacturing process to improve the environmental or ecological aspects; and
making a final product using the changed aspect of the product or its manufacturing process, wherein the final product has an improved product grade as compared to the initial product grade.

25. A method according to claim 24, further comprising:
marking the improved product grade on the product or packaging for the product.

26. A method according to claim 24, further comprising:
applying a tag to the product, wherein the tag includes the improved product grade indicated thereon.

27. A method according to claim 24, wherein the product is footwear.

28. A method according to claim 24, wherein the product is apparel.

29. A method according to claim 24, wherein the product is sports equipment.

30. A product grading system, comprising:
an input system for receiving input indicating one or more of: (a) a type or amount of toxic material used in making the product, (b) a type or amount of waste created in making the product, (c) a type or amount of environmentally preferred materials used in making the product, and (d) an extent to which the product or its manufacturing methods provide an advance over existing products or manufacturing methods; and
a processing system programmed and adapted to assign one or more of: (a) a toxic consumption value for the product based on the type or amount of toxic material, (b) a waste production value for the product based on the type or amount of waste, (c) a material value for the product based on the type or amount of environmentally preferred materials, (d) assign an advancement value for the product based on the determined extent, and wherein the processing system is further programmed and adapted to (e) determine a product grade based on the assigned value or values.

31. A system according to claim 30, further comprising:
an output system for marking the product grade on the product or packaging for the product.

32. A system according to claim 30, wherein the output system produces the product grade on the product.

33. A system according to claim 30, wherein the output system produces the product grade on packaging material for the product.

34. A system according to claim 30, wherein the output system produces the product grade on a tag for inclusion with the product.

35. A system according to claim 30, wherein the product is footwear.

36. A system according to claim 30, wherein the product is apparel.

37. A system according to claim 30, wherein the product is sports equipment.
